(19) United States
(12) Patent Application Publication
(10) Pub. No.: US 2026/0291618 A1
(43) Pub. Date: Sep. 24, 2026

(54) RECEIVING DEVICE, TRANSMITTING DEVICE, AND OPTICAL WIRELESS COMMUNICATION SYSTEM

(71) Applicant: TOYOTA JIDOSHA KABUSHIKI KAISHA, Aichi-ken (JP)

(72) Inventors: Shintaro SHIBA, Bunkyo-ku (JP); Norimasa KOBORI, Nakano-ku (JP)

(21) Appl. No.: 19/560,150

(22) Filed: Mar. 9, 2026

(30) Foreign Application Priority Data
Mar. 21, 2025 (JP) 2025-046920

(51) Int. Cl. H04B 10/60; H04B 10/116; H04B 10/50

(52) U.S. Cl. CPC H04B 10/60; H04B 10/116; H04B 10/50

(57) ABSTRACT

A receiving device includes: an event camera configured to detect a rising edge and a falling edge of luminance as events; and a controller configured to receive, through the event camera, an optical wireless communication signal transmitted from a transmitting device. In the optical wireless communication signal, data 0 is represented by a zeroth event set including one or more events, and data 1 is represented by a first event set including one or more events and being different from the zeroth event set. The controller is configured to recognize data represented by the optical wireless communication signal without referring to an interval between events.

### CROSS-REFERENCES TO RELATED APPLICATION

The present disclosure claims priority to Japanese Patent Application No. 2025-046920, filed on Mar. 21, 2025, the contents of which application are incorporated herein by reference in their entirety.

### TECHNICAL FIELD

The present disclosure relates to an optical wireless communication technique utilizing an event camera.

### BACKGROUND ART

Patent Literature 1 discloses a visible light communication device applicable to a vehicle. The visible light communication device acquires images captured by an in-vehicle camera. The image (frame) is obtained every 1/60 second. Each bit (data) is represented by a change in luminance of pixel between two consecutive frames. More specifically, an increase in luminance between two consecutive frames is associated with a bit “1”, while a decrease in luminance is associated with a bit “0”. A change in luminance between a bit and the next bit is not used for the visible light communication.

### List of Related Art

Patent Literature 1: Japanese Patent Application Publication No. 2017-085230

### SUMMARY

Regarding an optical wireless communication, let us consider a case where a receiving-side receives an optical wireless communication signal through an event camera. The event camera is capable of detecting a rising edge and a falling edge of luminance as events. An object of the present disclosure is to propose a novel protocol that is applicable to the optical wireless communication utilizing the event camera.

A first aspect relates to a receiving device.

The receiving device includes: an event camera configured to detect a rising edge and a falling edge of luminance as events; and a controller configured to receive, through the event camera, an optical wireless communication signal transmitted from a transmitting device.

In the optical wireless communication signal, data 0 is represented by a zeroth event set including one or more events. Data 1 is represented by a first event set including one or more events and being different from the zeroth event set.

The controller is configured to recognize data represented by the optical wireless communication signal without referring to an interval between events.

A second aspect relates to a transmitting device.

The transmission device includes a controller configured to transmit an optical wireless communication signal.

A receiving device for receiving the optical wireless communication signal is provided with an event camera that detects a rising edge and a falling edge of luminance as events, and is configured to receive the optical wireless communication signal through the event camera.

The controller represents data 0 in the optical wireless communication signal by a zeroth event set including one or more events. Moreover, the controller represents data 1 in the optical wireless communication signal by a first event set including one or more events and being different from the zeroth event set.

The receiving device is configured to recognize data represented by the optical wireless communication signal without referring to an interval between events.

A third aspect relates to an optical wireless communication system.

The optical wireless communication system includes: a transmitting device configured to transmit an optical wireless communication signal; and a receiving device configured to receive the optical wireless communication signal transmitted from the transmitting device.

The receiving device is provided with an event camera that detects a rising edge and a falling edge of luminance as events, and is configured to receive the optical wireless communication signal through the event camera.

The transmitting device represents data 0 in the optical wireless communication signal by a zeroth event set including one or more events. Moreover, the transmitting device represents data 1 in the optical wireless communication signal by a first event set including one or more events and being different from the zeroth event set.

The receiving device is configured to recognize data represented by the optical wireless communication signal without referring to an interval between events.

According to the present disclosure, a novel protocol applicable to the optical wireless communication utilizing the event camera is proposed. More specifically, the data in the optical wireless communication signal is represented by the event set that is independent of an interval between events. Accordingly, the receiving device is able to recognize the data represented by the optical wireless communication signal without the need to refer to the interval between events. Since a step of measuring the interval between events is eliminated, processing load in the receiving device is reduced.

### BRIEF DESCRIPTION OF DRAWINGS

FIG. 1 is a block diagram for explaining an overview of an optical wireless communication system;

FIG. 2 is a conceptual diagram showing a comparison between an optical wireless communication signal and noise;

FIG. 3 is a conceptual diagram for explaining an example of a protocol applied to an optical wireless communication utilizing an event camera;

FIG. 4 is a conceptual diagram for explaining a third protocol;

FIG. 5 is a conceptual diagram for explaining a modification example of a third protocol; and

FIG. 6 is a block diagram for explaining processing performed by a controller of a receiving device.

### DETAILED DESCRIPTION

### 1. Optical Wireless Communication Utilizing Event Camera

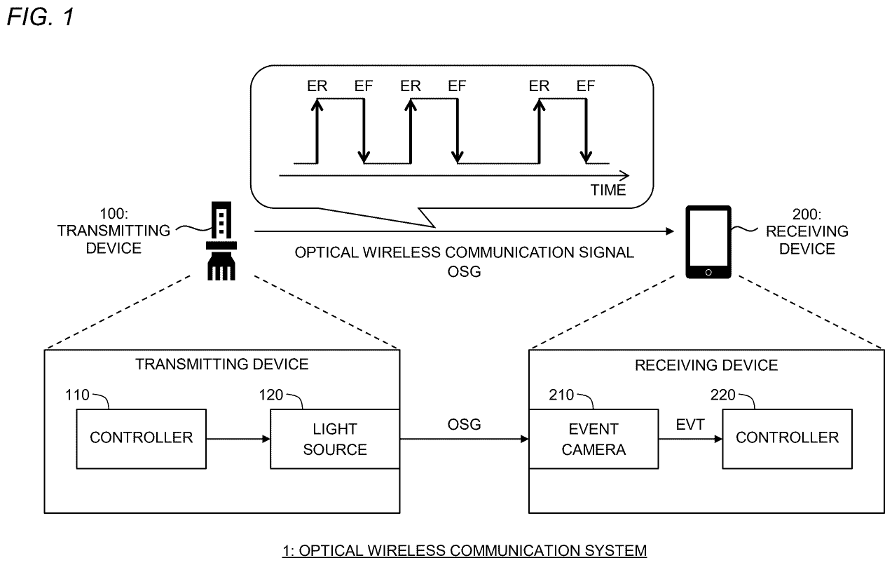

FIG. 1 is a block diagram for explaining an overview of an optical wireless communication system 1 according to the present embodiment. The optical wireless communication system 1 performs an optical wireless communication using light. Here, the term light includes visible light and infrared light. That is to say, the optical wireless communication encompasses both a visible light communication and an infrared light communication. The optical wireless communication system 1 includes a transmitting device 100 and a receiving device 200. The transmitting device 100 transmits (outputs) an optical wireless communication signal OSG composed of blinking of the light. The receiving device 200 receives the optical wireless communication signal OSG transmitted from the transmitting device 100.

The transmitting device 100 includes a controller 110 and a light source 120. The controller 110 includes one or more processors that execute a variety of processing, and one or more storage devices that store a variety of information. Examples of the processor include a central processing unit (CPU), an application specific integrated circuit (ASIC), a field-programmable gate array (FPGA), an integrated circuit, and the like. The processor may also be referred to as processing circuitry. Examples of the storage device include a volatile memory, a non-volatile memory, a hard disk drives (HDD), a solid state drives (SSD), and the like. An example of the light source 120 is a light emitting diode (LED).

The controller 110 encodes transmission data to generate a blinking pattern of the light source 120 that represents the transmission data. That is, the controller 110 converts the transmission data into a blinking pattern of the light source 120. Then, the controller 110 generates (outputs) an optical wireless communication signal OSG representing the transmission data, by causing the light source 120 to blink rapidly according to the blinking pattern.

The receiving device 200 includes an event camera 210 and a controller 220. The controller 220 includes one or more processors that execute a variety of processing, and one or more storage devices that store a variety of information. Examples of the processor include a CPU, an ASIC, an FPGA, an integrated circuit, and the like. The processor may also be referred to as processing circuitry. Examples of the storage device include a volatile memory, a non-volatile memory, an HDD, an SSD, and the like.

The event camera 210 is a camera configured to be capable of detecting a change in luminance as an event for each pixel. More specifically, the event camera 210 is equipped with an event-based vision sensor (EVS). The event-based vision sensor detects a change in luminance exceeding a threshold as an event. An increase in luminance is detected as a positive event, while a decrease in luminance is detected as a negative event. The event is detected for each pixel.

The event camera 210 is also capable of detecting a change in luminance caused by the optical wireless communication signal OSG. The optical wireless communication signal OSG includes a rising edge (leading edge) ER which is an increase in luminance, and a falling edge (trailing edge) EF which is a decrease in luminance. The event camera 210 detects the rising edge ER and the falling edge EF as a positive event and a negative event, respectively.

Event data EVT indicate a result of the event detection by the event camera 210. More specifically, the event data EVT represent a temporal and spatial distribution of the events detected by the event camera 210. The event data EVT include not only a signal component corresponding to the optical wireless communication signal OSG caused by the blinking of the light source 120, but also a noise component. For example, the noise component is caused by a change in a position or an orientation of the receiving device 200 (the event camera 210). As another example, the noise component may be caused by a change in a position or an orientation of the transmitting device 100 (the light source 120).

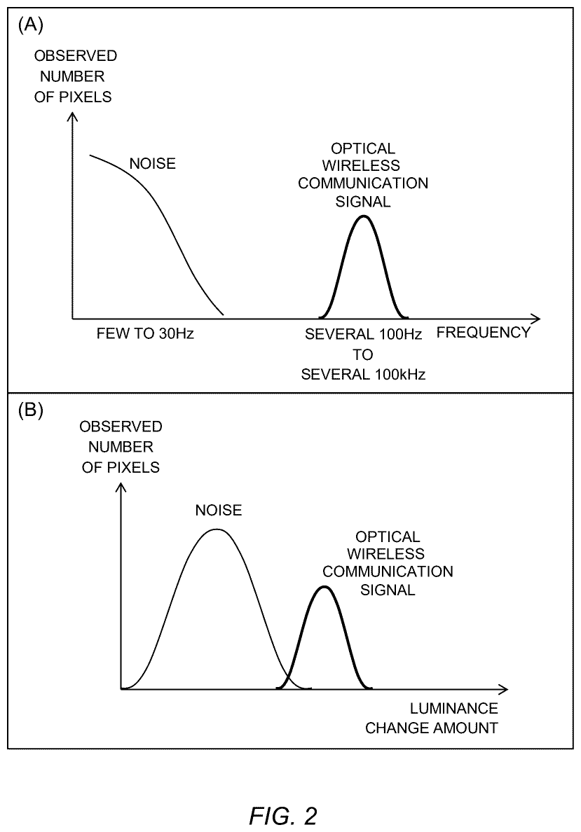

FIG. 2 is a conceptual diagram showing a comparison between the optical wireless communication signal OSG (i.e., the signal component) and the noise.

In a part (A) in FIG. 2, a vertical axis represents the number of pixels at which events are observed, and a horizontal axis represents a frequency. The frequency of the optical wireless communication signal OSG (i.e., the signal component) corresponds to a frequency of the blinking of the light source 120 and ranges from several hundred Hz to several hundred kHz. In contrast, a frequency of the noise is at most several Hz to 30 Hz. That is, there is a remarkable difference in the frequency band between the optical wireless communication signal OSG and the noise. Therefore, it is possible to easily separate the optical wireless communication signal OSG from the noise. For example, using a high-pass filter makes it possible to easily extract the signal component from the event data EVT.

In a part (B) in FIG. 2, a vertical axis represents the number of pixels at which events are observed, and a horizontal axis represents the amount of change in luminance. The amount of change in luminance of the optical wireless communication signal OSG (i.e., the signal component) is greater than that of the noise.

As described above, the event camera 210 is configured to detect a change in luminance as an event for each pixel. Regarding a pixel at which no change in luminance occurs, no event data EVT is generated in particular. On the other hand, a conventional camera needs to generate data for all pixels in every frame. Therefore, as compared with the conventional camera, the event camera 210 has advantages in less data, high-speed processing, and thus high temporal resolution. It can be said that such the high-speed and high temporal resolution event camera 210 has a high degree of affinity for high-speed blinking of the light source 120 such as an LED.

The controller 220 of the receiving device 200 receives the event data EVT indicating the result of the event detection by the event camera 210. Then, the controller 220 extracts the signal component corresponding to the optical wireless communication signal OSG from the event data EVT. For example, the controller 220 extracts the signal component from the event data EVT by utilizing a high-pass filter. Then, the controller 220 decodes the signal component to recognize the data represented by the optical wireless communication signal OSG (i.e., the transmission data transmitted from the transmitting device 100).

As described above, the controller 220 of the receiving device 200 is capable of receiving the high-frequency optical wireless communication signal OSG by utilizing the event camera 210. In other words, the controller 220 is capable of receiving the high-frequency optical wireless communication signal OSG through the event camera 210. Then, the controller 220 decodes the received optical wireless communication signal OSG to recognize the data represented by the optical wireless communication signal OSG (i.e., the transmission data transmitted from the transmitting device 100).

The transmitting device 100 is, for example, installed on a stationary object in a city. Examples of the stationary object in the city include a street lamp, a traffic signal, an electronic display board, and the like. The receiving device 200 is, for example, mounted on a mobile terminal. Examples of the mobile terminal include a smartphone, a tablet, an augmented reality terminal, and the like. As another example, the receiving device 200 may be mounted on a mobility such as a vehicle, a robot, and the like.

One example of applications of the optical wireless communication described above is localization (self-position estimation) by the receiving device 200 (controller 220). More specifically, the transmission data included in the optical wireless communication signal OSG transmitted from the transmitting device 100 indicates a position (an absolute position) of the light source 120 of the transmitting device 100 in an absolute coordinate system. Such the optical wireless communication signal OSG is repeatedly transmitted from the transmitting device 100. The receiving device 200 receives a plurality of optical wireless communication signals OSG from a plurality of transmitting devices 100, respectively. The receiving device 200 decodes the plurality of optical wireless communication signals OSG to recognize the respective absolute positions of the plurality of light sources 120. Meanwhile, the receiving device 200 can also acquire respective image coordinates of the plurality of light sources 120 in the image plane. The receiving device 200 is capable of estimating the position (absolute position) of the receiving device 200 in the absolute coordinate system by combining the respective absolute positions of the plurality of light sources 120 and the respective image coordinates of the plurality of light sources 120.

### 2. Examples of Protocol

As described above, according to the present embodiment, the optical wireless communication is performed using the event camera 210. The event camera 210 detects the rising edge ER and the falling edge EF of the optical wireless communication signal OSG as events. Therefore, it is necessary to represent each of data (bit) “0” and data (bit) “1” based on events.

A protocol defines how data “0” and data “1” are represented in the optical wireless communication signal OSG. In other words, the protocol defines a representation rule for data “0” and “1” in the optical wireless communication signal OSG. In still other words, the protocol defines a conversion rule between data “0” and “1” and the blinking pattern of the light source 120. Various examples are conceivable as the protocol applied to the optical wireless communication utilizing the event camera 210.

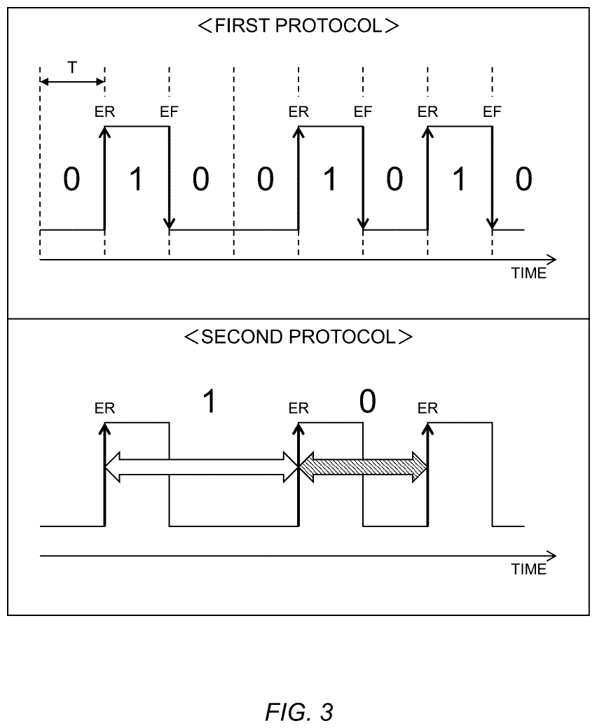

FIG. 3 is a conceptual diagram for explaining examples of the protocol applied to the optical wireless communication utilizing the event camera 210. Herein, two types of protocols, namely a first protocol and a second protocol, are introduced. It should be noted that a reference cycle (period) T is a predetermined cycle that serves as a basis for the data communications. A “rising edge ER”, a “falling edge EF”, or “no luminance change” occurs every reference cycle T.

A first protocol represents data “0” and “1” by using both the rising edge ER and the falling edge EF. More specifically, the first protocol represents data “0” and “1” based on whether or not there is a predetermined pattern of a combination of the rising edge ER and falling edge EF for each reference cycle T. For example, in the example illustrated in FIG. 3, a pair of a rising edge ER and a subsequent falling edge EF is associated with the data “1.” The rising edge ER and the falling edge EF are separated from each other by the reference cycle T. Patterns other than the above-mentioned pattern associated with the data “1” are associated with the data “0.” For example, a pair of a falling edge EF and no luminance change is associated with the data “0.” In addition, a pair of no luminance change and a rising edge ER is associated with the data “0.” Moreover, a pair of a falling edge EF and a subsequent rising edge ER is also associated with the data “0.” A pair of no luminance change and no luminance change is also associated with the data “0.”

On the other hand, a second protocol represents data “0” and “1” by using only one of the rising edge ER and the falling edge EF. More specifically, the second protocol uses only one of the rising edge ER and the falling edge EF as an onset, and represents data “0” and “1” based on an interval (period of time) between consecutive onsets. For example, in the example illustrated in FIG. 3, only the rising edge ER is used as the onset, whereas the falling edge EF is not used. A case where the interval between the consecutive rising edges ER is a first interval being relatively long is associated with the data “1.” On the other hand, another case where the interval between the consecutive rising edges ER is a second interval being relatively short is associated with the data “0.” The first interval is longer than the second interval. For example, the first interval is N times the reference cycle T, and the second interval is M times the reference cycle T. N and M both are integers, and N is greater than M.

### 3. Third Protocol

According to the first protocol and the second protocol shown in FIG. 3, the representation of the data in the optical wireless communication signal OSG depends on the interval between events. In these cases, the receiving device 200 needs to identify the data represented by the received optical wireless communication signal OSG based on the interval between events. Hereinafter, a third protocol is proposed as a novel protocol that is able to represent the data independently of the interval between events.

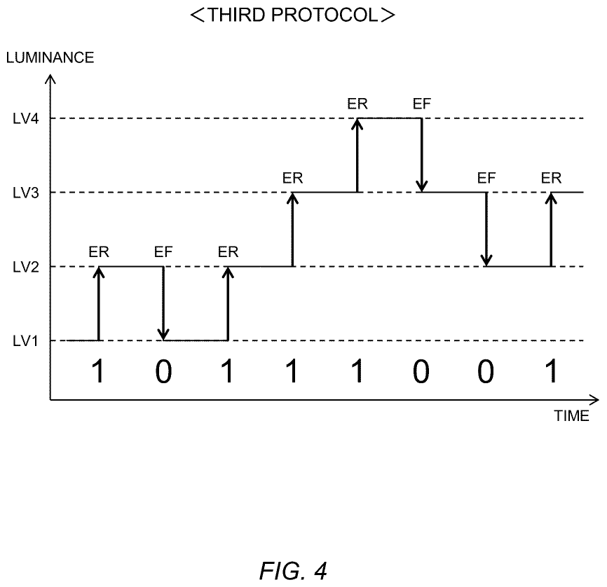

FIG. 4 is a conceptual diagram for explaining the third protocol. In the example shown in FIG. 4, the rising edge ER itself is associated with the data “1”, and the falling edge EF itself is associated with the data “0.” Alternatively, the rising edge ER itself may be associated with the data “0”, and the falling edge EF itself may be associated with the data “1.”

In this manner, the data in the optical wireless communication signal OSG is represented independently of the interval between events. Accordingly, the receiving device 200 is able to recognize the data represented by the optical wireless communication signal OSG without the need to refer to the interval between events. Since a step of measuring the interval between events is eliminated, processing load in the receiving device 200 is reduced.

It should be noted that according to the third protocol, three or more levels of luminance are used, instead of two levels of luminance such as light-ON and light-OFF. In other words, levels of the luminance of the optical wireless communication signal OSG include a lowest level, a highest level, and at least one intermediate level between the lowest level and the highest level. In the example shown in FIG. 4, two intermediate levels LV2 and LV3 are present between the lowest level LV1 and the highest level LV4. The luminance transitions among the four levels LV1 to LV4.

The number of levels of luminance is finite. Therefore, in the example shown in FIG. 4, it may not be possible to represent multiple repetitions of identical data (identical bits) such as “111111” or “000000.” In that case, a modification example of the third protocol as described below is effective.

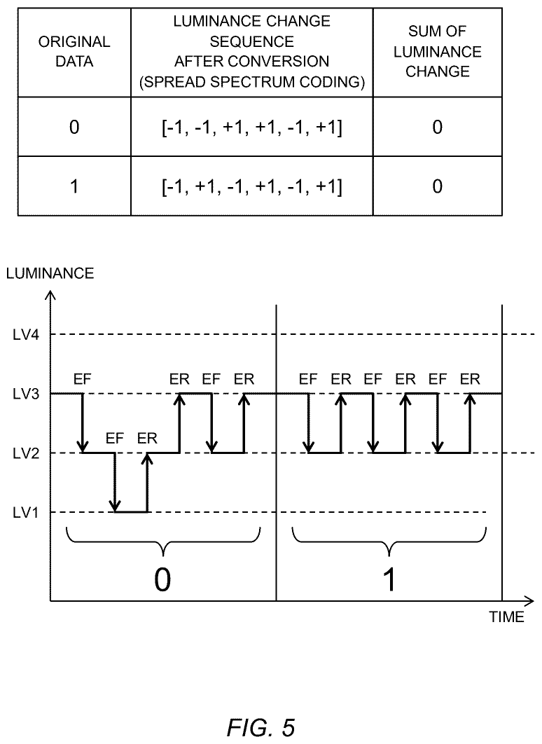

FIG. 5 is a conceptual diagram for explaining a modification of the third protocol. According to the modification example, the original data is converted into an “event set” that is a combination of two or more events. The event set may also be referred to as a “luminance change sequence.” More specifically, the original data “0” is converted into a “zeroth event set” that is a combination of two or more events. On the other hand, the original data “1” is converted into a “first event set” that is a combination of two or more events. The zeroth event set and the first event set are different from each other. Moreover, neither the zeroth event set nor the first event set depends on the “interval between events.”

Furthermore, as exemplified in FIG. 5, the number of rising edges ER and the number of falling edges EF included in the zeroth event set are equal to each other. In other words, regarding the zeroth event set as a whole, a sum of the luminance changes is zero and an average luminance is constant. Similarly, the number of rising edges ER and the number of falling edges EF included in the first event set are equal to each other. In other words, regarding the first event set as a whole, a sum of the luminance changes is zero and an average luminance is constant. It is thus possible to represent multiple repetitions of identical data (identical bits) such as “111111” or “000000” even when the number of levels of luminance is finite.

It should be noted that the levels of the luminance of the optical wireless communication signal OSG include the lowest level, the highest level, and at least one intermediate level between the lowest level and the highest level. Preferably, both the zeroth event set and the first event set start from the intermediate level (e.g., LV3).

A correspondence relationship between the original data “0” and the zeroth event set may be predefined. Similarly, a correspondence relationship between the original data “1” and the first event set may be predefined. A conversion map indicating the correspondence relationships is prepared in advance. The controller 110 of the transmitting device 100 retains the conversion map, and converts the original data into the corresponding event set based on the conversion map. The controller 220 of the receiving device 200 retains the conversion map, and converts the event set into the original data based on the conversion map.

Converting the original data into the event set is equivalent to “spread spectrum coding.” When encoding the transmission data, the controller 110 of the transmitting device 100 converts the transmission data into the event set by applying a spread spectrum coding matrix to the transmission data. When decoding the received event set, the controller 220 of the receiving device 200 restores the original data by applying an inverse matrix of the spread spectrum coding matrix to the event set. By utilizing the spread spectrum coding, it is possible to achieve robust optical wireless communication that is resistant to the noise.

The example shown in FIG. 4 and the modification example shown in FIG. 5 can be generalized as follows.

In the optical wireless communication signal OSG, the data “0” is represented by the “zeroth event set” including one or more events. On the other hand, the data “1” is represented by the “first event set” including one or more events. The zeroth event set and the first event set are different from each other. Furthermore, both the zeroth event set and the first event set are independent of the “interval between events.”

The controller 110 of the transmitting device 100 represents the data “0” in the optical wireless communication signal OSG by the zeroth event set, and represents the data “1” in the optical wireless communication signal OSG by the first event set. That is, the data in the optical wireless communication signal OSG is represented by the event set that is independent of the interval between events. The controller 220 of the receiving device 200 recognizes the data represented by the optical wireless communication signal OSG without referring to the interval between events. Since the step of measuring the interval between events is eliminated, the processing load in the receiving device 200 is reduced.

In the example shown in FIG. 4, the zeroth event set includes only one of the rising edge ER and the falling edge EF. The first event set includes only the other of the rising edge ER and the falling edge EF.

In the example shown in FIG. 5, the zeroth event set is a combination of two or more events. The number of rising edges ER and the number of falling edges EF included in the zeroth event set are equal to each other. Similarly, the first event set is a combination of two or more events. The number of rising edges ER and the number of falling edges EF included in the first event set are equal to each other. It is thus possible to represent multiple repetitions of identical data (identical bits) such as “111111” or “000000” even when the number of levels of luminance is finite.

The levels of the luminance of the optical wireless communication signal OSG include the lowest level, the highest level, and at least one intermediate level between the lowest level and the highest level. Preferably, both the zeroth event set and the first event set start from the intermediate level.

### 4. Example of Processing

The transmitting device 100 generates and transmits the optical wireless communication signal OSG using a certain protocol. More specifically, the controller 110 of the transmitting device 100 encodes transmission data in accordance with the certain protocol to generate a blinking pattern of the light source 120 that represents the transmission data. That is to say, the controller 110 converts the transmission data into a blinking pattern of the light source 120 in accordance with the certain protocol. Then, the controller 110 generates (outputs) the optical wireless communication signal OSG representing the transmission data, by causing the light source 120 to blink rapidly according to the blinking pattern.

The controller 220 of the receiving device 200 receives, through the event camera 210, the optical wireless communication signal OSG transmitted from the transmitting device 100. Here, if the protocol applied to the received optical wireless communication signal OSG is not identified, the controller 220 is not able to accurately recognize the data represented by the received optical wireless communication signal OSG.

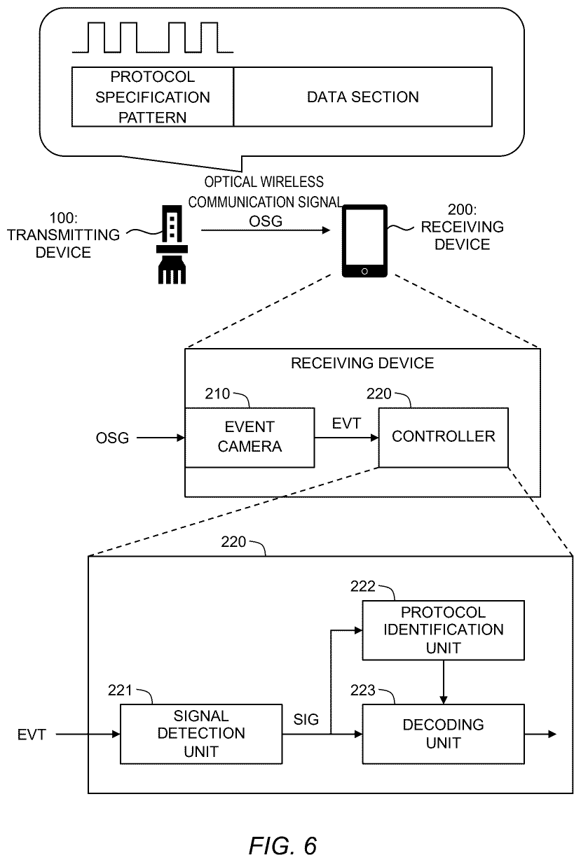

FIG. 6 is a block diagram for explaining the processing performed by the controller 220 of the receiving device 200 according to the present embodiment. The controller 220 includes a signal detection unit 221, a protocol identification unit 222, and a decoding unit 223 as functional blocks.

The signal detection unit 221 receives the event data EVT indicating the result of the event detection from the event camera 210. The signal detection unit 221 detects start (commencement) of reception of the optical wireless communication signal OSG based on the event data EVT.

For example, the signal detection unit 221 detects the start of the reception of the optical wireless communication signal OSG based on the event occurrence frequency at each pixel of the event camera 210. As shown in the part (A) of FIG. 2, there is a remarkable difference in the frequency band between the optical wireless communication signal OSG (i.e., the signal component) and the noise. The frequency band of the optical wireless communication signal OSG is a specific high-frequency band (i.e., several hundred Hz to several hundred kHz). Accordingly, monitoring presence or absence of events of the specific high-frequency band makes it possible to determine whether the reception of the optical wireless communication signal OSG is started or not. More specifically, the signal detection unit 221 calculates the event occurrence frequency for each pixel based on the event data EVT. When the event occurrence frequency falling within the specific high-frequency band is detected, the signal detection unit 221 determines that the reception of the optical wireless communication signal OSG is started, that is, detects the start of the reception of the optical wireless communication signal OSG.

As another example, the signal detection unit 221 may detect the start of the reception of the optical wireless communication signal OSG based on a change in the total amount of the event data EVT observed across all pixels of the event camera 210. As shown in FIG. 2, when the reception of the optical wireless communication signal OSG is started, the total amount of the event data EVT increases significantly accordingly. Therefore, monitoring the total amount of the event data EVT makes it possible to detect the start of the reception of the optical wireless communication signal OSG without the need to calculate the event occurrence frequency. For example, when the amount of increase in the event data EVT per unit time exceeds a threshold value, the signal detection unit 221 determines that the reception of the optical wireless communication signal OSG is started, that is, detects the start of the reception of the optical wireless communication signal OSG.

Upon detecting the start of the reception of the optical wireless communication signal OSG, the signal detection unit 221 separates the received optical wireless communication signal OSG from the noise. That is, the signal detection unit 221 extracts the signal component corresponding to the received optical wireless communication signal OSG from the event data EVT. For example, the signal detection unit 221 uses a high-pass filter to extract the signal component of the high-frequency band from the event data EVT.

In response to detecting the start of the reception of the optical wireless communication signal OSG, the protocol identification unit 222 identifies the protocol applied to the received optical wireless communication signal OSG. Hereinafter, the protocol applied to the optical wireless communication signal OSG is referred to as an “applied protocol.” The process of identifying the applied protocol applied to the received optical wireless communication signal OSG is hereinafter referred to as a “protocol identification process.”

An example of the protocol identification process is as follows. In the present example, the optical wireless communication signal OSG having the same content is repeatedly transmitted from the same transmitting device 100. Each optical wireless communication signal OSG includes a “protocol specification pattern” in addition to a data section. The data section is a section that represents the transmission data. On the other hand, the protocol specification pattern indicates the applied protocol that is applied to this optical wireless communication signal OSG. For example, the protocol specification pattern is embedded in a preamble of the optical wireless communication signal OSG.

More specifically, the protocol specification pattern is a pattern of a combination of the rising edge ER and the falling edge EF. When the applied protocol is the first protocol, the protocol specification pattern is a first protocol specification pattern. When the applied protocol is the second protocol, the protocol specification pattern is a second protocol specification pattern. When the applied protocol is the third protocol, the protocol specification pattern is a third protocol specification pattern. The first to third protocol specification patterns are set to be different from each other, and are given as known patterns.

The controller 110 of the transmitting device 100 retains in advance information regarding the i-th protocol specification pattern (i=1 to 3). The information regarding the i-th protocol specification pattern is stored in the storage device of the controller 110. The controller 110 generates the optical wireless communication signal OSG so as to include the protocol specification pattern indicating the applied protocol.

The controller 220 of the receiving device 200 also retains in advance the information regarding the i-th protocol specification pattern (i=1 to 3). The information regarding the i-th protocol specification pattern is stored in the storage device of the controller 220. The protocol identification unit 222 of the controller 220 executes the protocol identification process based on the received optical wireless communication signal OSG. More specifically, the protocol identification unit 222 identifies the applied protocol applied to the received optical wireless communication signal OSG, based on the protocol specification pattern included in the received optical wireless communication signal OSG.

The decoding unit 223 receives the signal component corresponding to the received optical wireless communication signal OSG from the signal detection unit 221. In addition, the decoding unit 223 receives the information regarding the applied protocol applied to the received optical wireless communication signal OSG from the protocol identification unit 222. After the protocol identification process, the decoding unit 223 decodes the signal component in accordance with the applied protocol to recognize the original data (the transmission data) represented by the optical wireless communication signal OSG. That is, the decoding unit 223 converts the signal component into the original data (the transmission data) in accordance with the applied protocol. It should be noted that when the applied protocol is the third protocol, it is not necessary to refer to the interval between events.

The obtained original data is used in subsequent processes. For example, the obtained original data is used for localization (self-position estimation) of the receiving device 200.

It should be noted that, once the applied protocol is identified by the protocol identification process, the same applied protocol may continue to be used for a predetermined period of time thereafter. After a predetermined period of time has elapsed, the protocol identification process may be performed again.

The transmitting device 100 may randomly change the applied protocol at a predetermined interval. The receiving device 200 is able to follow the change in the applied protocol by means of the aforementioned protocol identification process. Randomly changing the applied protocol can increase security.

What is claimed is:

1. A receiving device comprising:
an event camera configured to detect a rising edge and a falling edge of luminance as events; and
a controller configured to receive, through the event camera, an optical wireless communication signal transmitted from a transmitting device, wherein
in the optical wireless communication signal, data 0 is represented by a zeroth event set including one or more events,
in the optical wireless communication signal, data 1 is represented by a first event set including one or more events and being different from the zeroth event set, and
the controller is configured to recognize data represented by the optical wireless communication signal without referring to an interval between events.

2. The receiving device according to claim 1, wherein
the zeroth event set is a combination of two or more events,
a number of rising edges and a number of falling edges included in the zeroth event set are equal to each other,
the first event set is a combination of two or more events, and
a number of rising edges and a number of falling edges included in the first event set are equal to each other.

3. The receiving device according to claim 2, wherein
levels of the luminance of the optical wireless communication signal include a lowest level, a highest level, and at least one intermediate level between the lowest level and the highest level, and
the zeroth event set and the first event set start from the intermediate level.

4. The receiving device according to claim 1, wherein
the zeroth event set includes only one of the rising edge and the falling edge, and
the first event set includes only another of the rising edge and the falling edge.

5. A transmission device comprising:
a controller configured to transmit an optical wireless communication signal, wherein
a receiving device for receiving the optical wireless communication signal is provided with an event camera that detects a rising edge and a falling edge of luminance as events, and is configured to receive the optical wireless communication signal through the event camera,
the controller is configured to:
represent data 0 in the optical wireless communication signal by a zeroth event set including one or more events; and
represent data 1 in the optical wireless communication signal by a first event set including one or more events and being different from the zeroth event set, and
the receiving device is configured to recognize data represented by the optical wireless communication signal without referring to an interval between events.

6. An optical wireless communication system comprising:
a transmitting device configured to transmit an optical wireless communication signal; and
a receiving device configured to receive the optical wireless communication signal transmitted from the transmitting device, wherein
the receiving device is provided with an event camera that detects a rising edge and a falling edge of luminance as events, and is configured to receive the optical wireless communication signal through the event camera,
the transmitting device is configured to:
represent data 0 in the optical wireless communication signal by a zeroth event set including one or more events; and
represent data 1 in the optical wireless communication signal by a first event set including one or more events and being different from the zeroth event set, and
the receiving device is configured to recognize data represented by the optical wireless communication signal without referring to an interval between events.
